(19) United States
(12) Patent Application Publication
(10) Pub. No.: US 2023/0318004 A1
(43) Pub. Date: Oct. 5, 2023

(54) METHOD FOR MANUFACTURING FUEL CELL STACK AND METHOD FOR MANUFACTURING JOINT SEPARATOR

(71) Applicant: HONDA MOTOR CO., LTD., Tokyo (JP)

(72) Inventor: Hiroyuki ISHIKAWA, WAKO-SHI (JP)

(21) Appl. No.: 18/125,386

(22) Filed: Mar. 23, 2023

(30) Foreign Application Priority Data
Mar. 31, 2022 (JP) 2022-060205

(51) Int. Cl. H01M 8/2465; H01M 8/1004; H01M 8/0232

(52) U.S. Cl. CPC H01M 8/2465; H01M 8/1004; H01M 8/0232

(57) ABSTRACT

In the method of manufacturing the fuel cell stack and the method of manufacturing the joint separator, a joint separator is formed by joining a first metal separator and a second metal separator to each other in a state of being stacked together in a thickness direction in a manner so that bead structures of the first separator and the second separator protrude outward, and then a preliminary load is applied to the passage bead portions and the outer peripheral bead portions while suppressing deformation of a portion in a gap of a double bead portion of each of the first and second separators, the double bead portions being formed by the passage bead portion and the outer peripheral bead portion extending in parallel to each other at a narrow interval.

### CROSS-REFERENCE TO RELATED APPLICATIONS

This application is based upon and claims the benefit of priority from Japanese Patent Application No. 2022-060205 filed on Mar. 31, 2022, the contents of which are incorporated herein by reference.

### BACKGROUND OF THE INVENTION

### Field of the Invention

The present invention relates to a method for manufacturing a fuel cell stack and a method for manufacturing a joint separator.

### Description of the Related Art

In recent years, research and development have been conducted on fuel cell stacks that contribute to energy efficiency in order to ensure that more people have access to affordable, reliable, sustainable and modern energy.

### SUMMARY OF THE INVENTION

In the art of fuel cells, a metal separator (also referred to as a bipolar plate) has a sealing structure using beads, in order to seal reactant gases (JP 6368807 B2). Such a metal separator is required to have a seal structure with high dimension accuracy. The bead having a variation in height has low sealing performance and causes a problem such as leakage of the reactant gas. In particular, a portion called a double bead in which two beads are adjacent to each other at a narrow interval is easily deformed, so that the seal surface pressure is liable to be relatively reduced. Thus, the portion is easily affected by variations in the height of the beads.

An object of the present invention is to solve the aforementioned problem.

According to an aspect of the present invention, there is provided a method for manufacturing a fuel cell stack including a plurality of power generation cells each including a membrane electrode assembly and a pair of metal separators sandwiching the membrane electrode assembly therebetween, the method including: a forming step of forming each of a first metal separator and a second metal separator by press forming a metal plate, the first metal separator and the second metal separator each including a reactant gas flow field through which a reactant gas flows along the membrane electrode assembly, an outer peripheral bead portion surrounding a periphery of the reactant gas flow field, a passage penetrating therethrough in a separator thickness direction and through which the reactant gas or a coolant flows, and a passage bead portion surrounding the passage; a joining step of joining the first metal separator and the second metal separator to each other in a state of being stacked together in a thickness direction in a manner so that the outer peripheral bead portion of the first metal separator and the outer peripheral bead portion of the second metal separator protrude outward, to thereby form a joint separator; a preliminary pressing step of applying a preliminary load to the outer peripheral bead portions and the passage bead portions of the joint separator to thereby plastically deform the outer peripheral bead portions and the passage bead portions; and an assembly step of stacking the joint separator and the membrane electrode assembly, wherein, in the preliminary pressing step, the preliminary load is applied to the outer peripheral bead portions and the passage bead portions while suppressing deformation of a portion between the passage bead portion and the outer peripheral bead portion in a double bead portion formed by the passage bead portion and the outer peripheral bead portion extending in parallel to each other.

According to another aspect of the present invention, there is provided a method for manufacturing a joint separator for use in a fuel cell stack, the method including: a forming step of forming each of a first metal separator and a second metal separator by press forming a metal plate, the first metal separator and the second metal separator each including a reactant gas flow field through which a reactant gas flows along a membrane electrode assembly, an outer peripheral bead portion surrounding a periphery of the reactant gas flow field, a passage penetrating therethrough in a separator thickness direction and through which the reactant gas or a coolant flows, and a passage bead portion surrounding the passage; a joining step of joining the first metal separator and the second metal separator to each other in a state of being stacked together in a thickness direction in a manner so that the outer peripheral bead portion of the first metal separator and the outer peripheral bead portion of the second metal separator protrude outward, to thereby form a joint separator; and a preliminary pressing step of applying a preliminary load to the outer peripheral bead portions and the passage bead portions of the joint separator to thereby plastically deform the outer peripheral bead portions and the passage bead portions, wherein, in the preliminary pressing step, the preliminary load is applied to the outer peripheral bead portions and the passage bead portions while suppressing deformation of a portion between the passage bead portion and the outer peripheral bead portion in a double bead portion formed by the outer peripheral bead portion and the passage bead portion extending in parallel to each other.

In the fuel cell stack manufacturing method and the joint separator manufacturing method according to the above-described aspects, it is possible to suppress variation in the height of the bead.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view of a fuel cell stack according to an embodiment;

FIG. 2 is a flowchart showing a method for manufacturing a joint separator according to the embodiment;

FIG. 3A is a partially enlarged view of a double bead of a first metal separator and its vicinity;

FIG. 3B is a cross sectional view taken along line IIIB-IIIB in FIG. 3A;

FIG. 4A is a cross-sectional view of a second metal separator;

FIG. 4B is an explanatory view of a welding step;

FIG. 5A is an explanatory view of a step of forming a micro seal;

FIG. 5B is a cross-sectional view showing a mounting portion of a deformation suppressing member;

FIG. 6A is a plan view showing the mounting portion of the deformation suppressing member;

FIG. 6B is an explanatory view of a preliminary pressing step;

FIG. 7A is an explanatory view of the joint separator before preliminary pressing;

FIG. 7B is an explanatory view of the joint separator after the preliminary pressing according to the embodiment;

FIG. 8A is an explanatory diagram of a preliminary pressing step according to a first modification of the embodiment; and

FIG. 8B is an explanatory diagram of a preliminary pressing step according to a second modification of the embodiment.

### DETAILED DESCRIPTION OF THE INVENTION

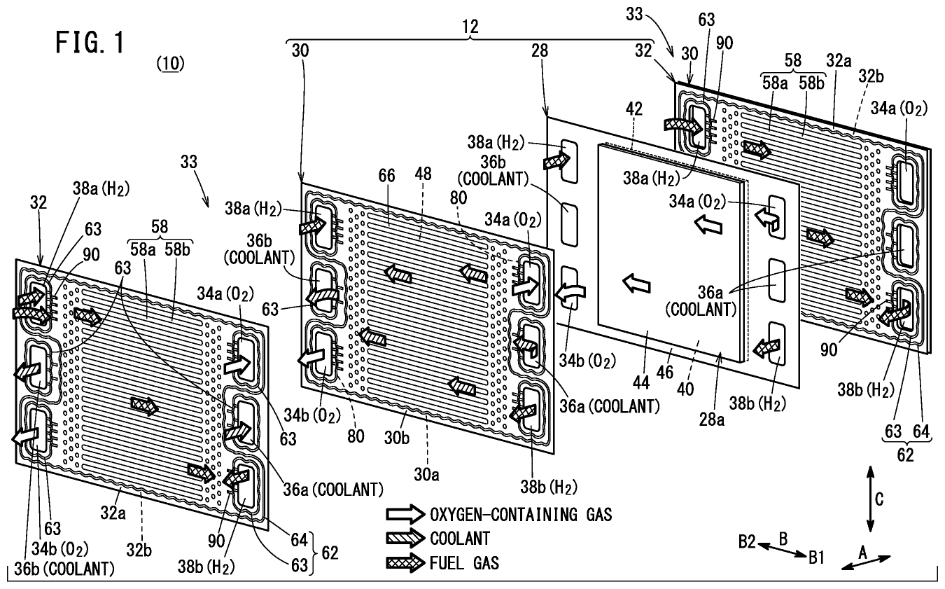

As shown in FIG. 1, a power generation cell 12 serving as a unit fuel cell includes a resin frame equipped membrane electrode assembly (which will hereinafter be referred to as MEA) 28, a first metal separator 30, and a second metal separator 32. The first metal separator 30 is disposed on one side of the MEA 28 in the thickness direction (the direction of arrow A). The second metal separator 32 is disposed on the other side of the MEA 28 in the thickness direction. A fuel cell stack 10 includes a plurality of the power generation cells 12. The plurality of power generation cells 12 of the fuel cell stack 10 are stacked in, for example, the direction of arrow A (horizontal direction) or the direction of arrow C (gravity direction). In the fuel cell stack 10, a tightening load (compression load) in the stacking direction is applied to the plurality of power generation cells 12. For example, the fuel cell stack 10 is mounted as an in-vehicle fuel cell stack in a fuel cell electric automobile (not shown).

Each of the first metal separator 30 and the second metal separator 32 is made of a thin metal plate such as a steel plate, a stainless steel plate, an aluminum plate, or a plated steel plate. The metal surfaces of the first metal separator 30 and the second metal separator 32 are subjected to anti-corrosion surface treatment. Each of the first metal separator and the second metal separator 32 has a corrugated cross-sectional shape formed by press forming. A joint separator 33 is disposed between the power generation cells 12 adjacent to each other. The joint separator 33 is a component obtained by integrally joining the first metal separator 30 belonging to one power generation cell 12 and the second metal separator 32 belonging to another power generation cell 12 by welding.

The power generation cell 12 has an oxygen-containing gas supply passage 34a, a coolant supply passage 36a, and a fuel gas discharge passage 38b at one end thereof in the horizontal direction, which is the longitudinal direction thereof (the end on the side of the arrow B1 direction). The oxygen-containing gas supply passage 34a, the coolant supply passage 36a, and the fuel gas discharge passage 38b extend in the stacking direction (the direction of arrow A).

The oxygen-containing gas supply passage 34a, the coolant supply passage 36a, and the fuel gas discharge passage 38b are arranged in the vertical direction (in the direction of arrow C). An oxygen-containing gas is supplied through the oxygen-containing gas supply passage 34a. A coolant, for example, water, is supplied through the coolant supply passage 36a. A fuel gas such as a hydrogen-containing gas is discharged through the fuel gas discharge passage 38b.

The power generation cell 12 has a fuel gas supply passage 38a, a coolant discharge passage 36b, and an oxygen-containing gas discharge passage 34b at the other end thereof in the horizontal direction, which is the longitudinal direction thereof (the end on the side of the arrow B2 direction). The fuel gas supply passage 38a, the coolant discharge passage 36b, and the oxygen-containing gas discharge passage 34b extend in the stacking direction. The fuel gas supply passage 38a, the coolant discharge passage 36b, and the oxygen-containing gas discharge passage 34b are arranged in the vertical direction.

The fuel gas is supplied through the fuel gas supply passage 38a. The coolant is discharged through the coolant discharge passage 36b. The oxygen-containing gas is discharged through the oxygen-containing gas discharge passage 34b. The layout of the oxygen-containing gas supply passage 34a, the oxygen-containing gas discharge passage 34b, the fuel gas supply passage 38a, and the fuel gas discharge passage 38b is not limited to the above embodiment, and may be changed depending on the required specification.

The MEA 28 includes a membrane electrode assembly 28a and a frame-shaped resin film 46 provided on an outer periphery of the membrane electrode assembly 28a. The membrane electrode assembly 28a includes an electrolyte membrane 40, and an anode 42 and a cathode 44 sandwiching the electrolyte membrane 40 therebetween.

The first metal separator 30 has an oxygen-containing gas flow field 48 extending in the direction indicated by the arrow B on a surface 30a facing the MEA 28. The first metal separator has a first bead structure 52 (metal bead seal) formed by press forming, on the surface 30a. The first bead structure 52 is a ridge-shaped structure that bulges toward the MEA 28 (FIG. 1). The first bead structure 52 has a resin material firmly fixed to a top portion thereof by printing, coating, or the like. The resin material enhances close contact between the first bead structure 52 and the MEA 28.

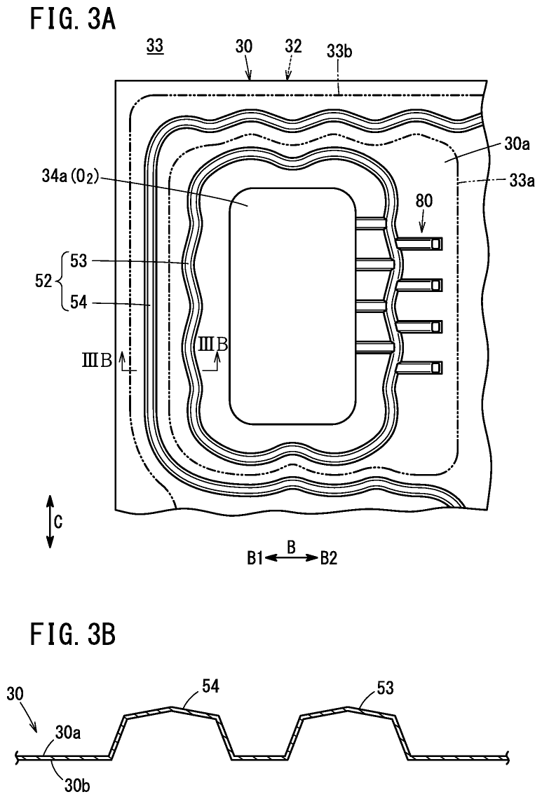

As shown in FIG. 3A, the first bead structure 52 includes passage bead portions 53 surrounding respectively the plurality of passages (for example, the oxygen-containing gas supply passage 34a), and an outer peripheral bead portion 54 surrounding the oxygen-containing gas flow field 48. Some of the passage bead portions 53 each have a bridge section 80. The bridge section 80 forms a flow path extending through the passage bead portion 53, and allows the reactant gas to flow between the passage and the oxygen-containing gas flow field 48.

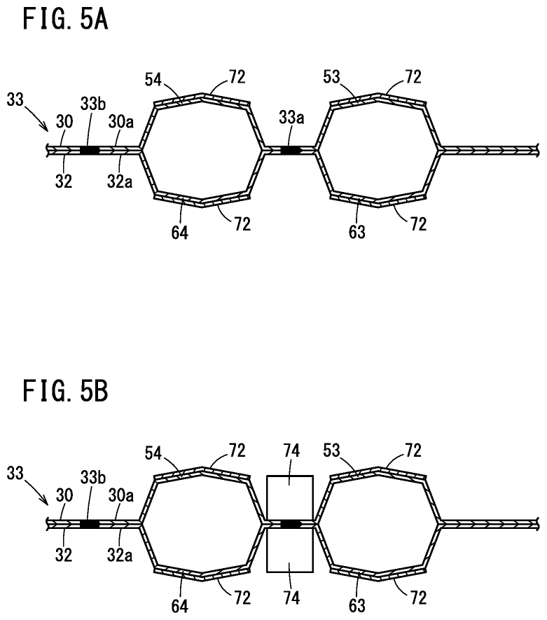

As shown in FIG. 5A, the first metal separator 30 has a recessed portion on the back side of the ridge-shaped passage bead portion 53. The recessed portion forms an internal space of the passage bead portion 53. The recessed portion is arranged face-to-face with a recessed portion of the second metal separator 32, which will be described later.

The passage bead portion 53 has a pair of side walls. The side walls are inclined with respect to the separator thickness direction. Therefore, the passage bead portion 53 has a trapezoidal cross-sectional shape. The passage bead portion 53 is elastically deformed when a tightening load is applied in the stacking direction. The side walls of the passage bead portion 53 may be parallel to the separator thickness direction.

The outer peripheral bead portion 54 extends along the long sides of the first metal separator 30 facing each other. In one end side of the first metal separator 30 in the longitudinal direction (one end on the side of the direction indicated by the arrow B1), the outer peripheral bead portion 54 extends so as to wind its way between the oxygen-containing gas supply passage 34a, the coolant supply passage 36a, and the fuel gas discharge passage 38b, which are arranged side by side in the short-side direction of the first metal separator 30.

In the other end side of the first metal separator 30 in the longitudinal direction (one end on the side of the direction indicated by the arrow B2), the outer peripheral bead portion 54 extends so as to wind its way between the fuel gas supply passage 38a, the coolant discharge passage 36b, and the oxygen-containing gas discharge passage 34b, which are arranged side by side in the short-side direction of the first metal separator 30. The passage bead portion 53 is disposed in a region surrounded by the outer peripheral bead portion 54.

As shown in FIG. 3A, the passage bead portion 53 and the outer peripheral bead portion 54 form two bead seals (a double bead portion) arranged in two rows so as to be adjacent to each other at a narrow interval, around the oxygen-containing gas supply passage 34a.

Like the passage bead portion 53, the outer peripheral bead portion 54 has a trapezoidal cross-sectional shape taken along the separator thickness direction. Note that the outer peripheral bead portion 54 may have a rectangular cross-sectional shape taken along the separator thickness direction. The passage bead portion 53 and the outer peripheral bead portion 54 preferably have the same cross-sectional shape. From the viewpoint of generating a uniform seal surface pressure, it is preferable that the protrusion height of the passage bead portion 53 and the protrusion height of the outer peripheral bead portion 54 are equal to each other.

As shown in FIG. 1, in the first metal separator 30, the double bead portion formed by the passage bead portion 53 and the outer peripheral bead portion 54 are formed also around the oxygen-containing gas discharge passage 34b, the fuel gas supply passage 38a, and the fuel gas discharge passage 38b.

As shown in FIG. 1, the second metal separator 32 has a fuel gas flow field 58 on its surface 32a facing the MEA 28. The fuel gas flow field 58 extends in the direction of arrow B. The fuel gas flow field 58 communicates fluidically with the fuel gas supply passage 38a and the fuel gas discharge passage 38b. The fuel gas flow field 58 includes flow grooves 58b between a plurality of ridges 58a extending in the direction of arrow B.

The second metal separator 32 has a second bead structure 62 on the surface 32a. The second bead structure 62 is a ridge-shaped structure that seals the fuel gas flow field 58. The second bead structure 62 bulges toward the MEA 28. The second bead structure 62 may have a resin material on the top. The resin material enhances the sealing performance of the second bead structure 62.

The second bead structure 62 includes passage bead portions 63 surrounding respectively the plurality of passages, and an outer peripheral bead portion 64 surrounding the fuel gas flow field 58. The plurality of passage bead portions 63 respectively surround the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b. Some of the passage bead portions 63 each have a bridge section 90. The bridge section 90 forms a flow path for the reactant gas that passes through the passage bead portion 63.

As shown in FIG. 3A, the first metal separator 30 and the second metal separator 32 constituting the joint separator 33 are joined to each other by laser welding lines 33a and 33b. The laser welding lines 33a surround the passage bead portions 53, 63, respectively. The laser welding line 33b surrounds the outer periphery of the outer peripheral bead portions 54, 64. The first metal separator 30 and the second metal separator 32 may be joined together by brazing instead of welding.

The joint separator 33 described above is manufactured by the following manufacturing method.

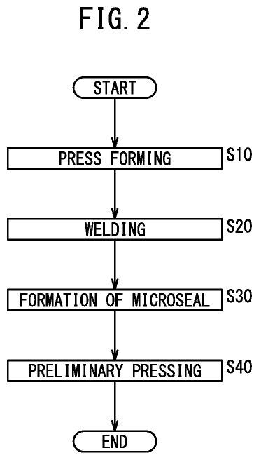

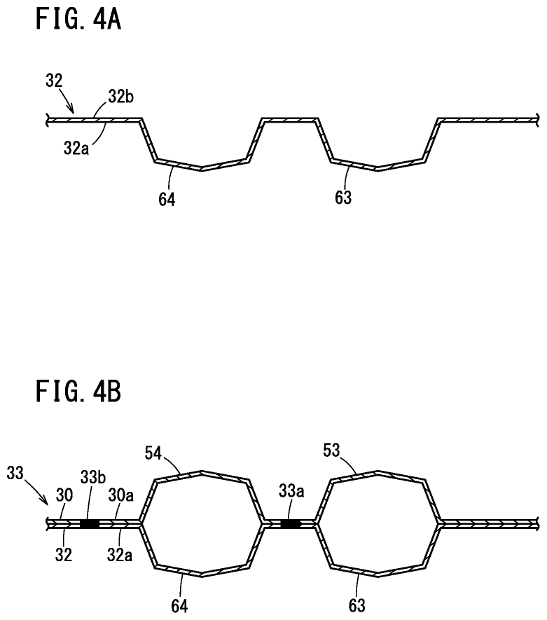

As shown in step S10 of FIG. 2, press forming is performed on a metal thin plate. Through this step, the first metal separator 30 and the second metal separator 32 are formed. As shown in FIGS. 3A and 3B, in the first metal separator 30, the oxygen-containing gas flow field 48 and the first bead structure 52 (the passage bead portion 53 and the outer peripheral bead portion 54) that seals the oxygen-containing gas flow field 48 are formed. As shown in FIG. 4A, in the second metal separator 32, the fuel gas flow field 58 and the second bead structure 62 (the passage bead portion 63 and the outer peripheral bead portion 64) that seals the fuel gas flow field 58 are formed.

Next, as shown in step S20 of FIG. 2, the first metal separator 30 and the second metal separator 32 are joined together by welding. By this step, as shown in FIG. 4B, the joint separator 33 is formed in which the back surface 30b of the first metal separator 30 and the back surface 32b of the second metal separator 32 are joined together so as to face each other. In the joint separator 33, the passage bead portion 53 and the passage bead portion 63 are arranged face-to-face with each other in the thickness direction, and the outer peripheral bead portion 54 and the outer peripheral bead portion 64 are arranged face-to-face with each other in the thickness direction.

Next, as shown in step S30 of FIG. 2, microseal (resin material 72) is applied onto the top portions of the first bead structure 52 and the second bead structure 62. In this step, as shown in FIG. 5A, a rubber material is applied, as the microseal, to the top portions of the first bead structure 52 and the second bead structure 62. The applied rubber material is heated and cured (hardened) to thereby coat the top portions of the first bead structure 52 and the second bead structure 62 with the rubber material (the resin material 72).

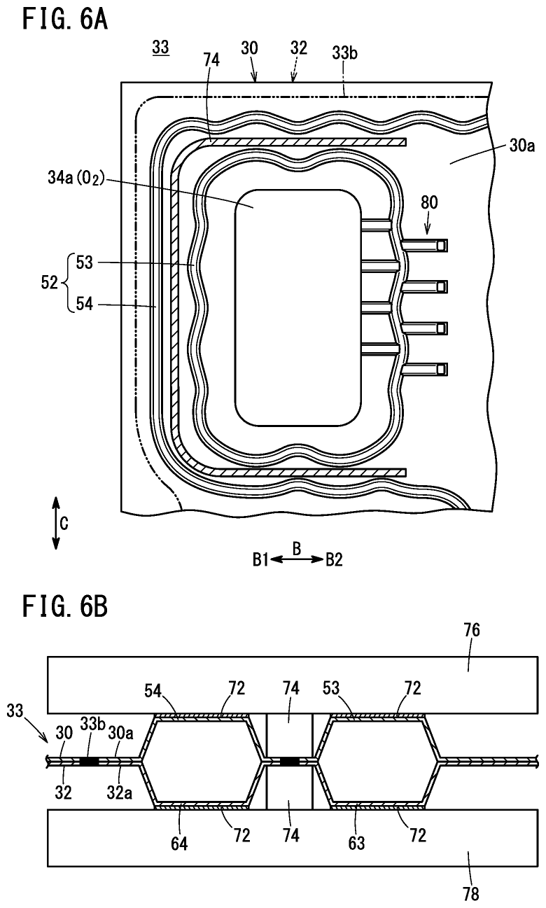

Next, as shown in step S40 of FIG. 2, preliminary pressing is performed on the joint separator 33. The preliminary pressing is a step of applying a load to the passage bead portions 53 and 63 and the outer peripheral bead portions 54 and 64 of the joint separator 33 at the same time to thereby correct the shapes thereof so as to uniform the heights of the passage bead portions 53 and 63 and the outer peripheral bead portions 54 and 64. In the present embodiment, before the load is applied to the joint separator 33, deformation suppressing members 74 are disposed respectively on the surface 30a of the first metal separator 30 and the surface 32a of the second metal separator 32, as shown in FIGS. 5B and 6A. As shown in FIG. 5B, the deformation suppressing member 74 is made of a resin sheet having a width smaller than the gap between the bead seals of the double bead portion. As shown in FIG. 6A, the deformation suppressing member 74 is disposed only in a narrow space of the gap of the double bead portion. The deformation suppressing member 74 has an adhesive layer on a surface thereof that is to be attached to the surface 30a, 32a. As shown in FIG. 5B, the thickness of the deformation suppressing member 74 has the same size (the same dimension in the thickness direction) as the protruding height of the finished first bead structure 52 and the finished second bead structure 62. The deformation suppressing members 74 are preferably disposed near the respective four corners of each of the first metal separator 30 and the second metal separator 32 each having a quadrangular shape. By disposing the deformation suppressing members 74 at the corners of the first metal separator 30 and the second metal separator 32, the sealing performance of the outer peripheral bead portions 54, 64 is further improved suitably.

Thereafter, as shown in FIG. 6B, the joint separator 33 is disposed between an upper die 76 (plate member) and a lower die 78 (plate member). In the preliminary pressing, the joint separator 33 is pressed in the thickness direction by the upper die 76 and the lower die 78. More specifically, the preliminary pressing is performed by applying a load that causes plastic deformation of the passage bead portions 53, 63 and the outer peripheral bead portions 54, 64 to thereby achieve the uniformity in height of the passage bead portions 53, 63 and the outer peripheral bead portions 54, 64.

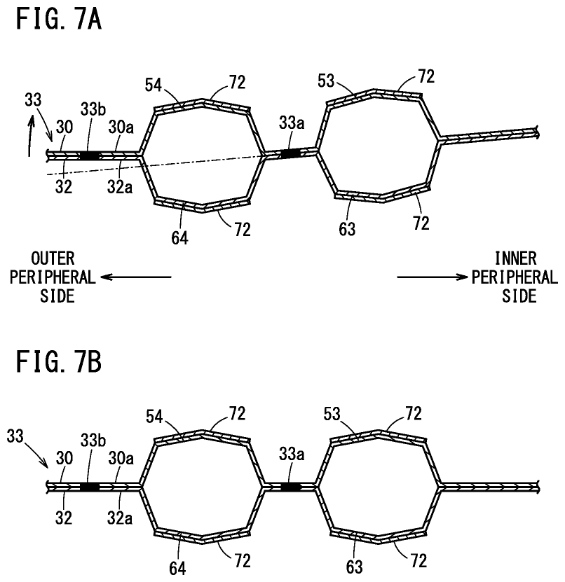

As shown in FIG. 7A, the joint separator 33 before the preliminary pressing is subjected to distortion due to heat of welding and consequently the joint separator 33 has a shape in which the joint separator 33 gradually warps toward one side in the thickness direction, from the central portion (inner peripheral side) toward the outer peripheral side. If the preliminary pressing is performed without disposing the deformation suppressing member 74 in the gap of the double bead portion, distortion in the gap of the double bead portion is not eliminated but remains. Therefore, even if the preliminary pressing is performed, variation occurs in the heights of the passage bead portions 53, 63 and the outer peripheral bead portions 54, 64.

On the other hand, in the manufacturing method according to the present embodiment, the deformation suppressing member 74 is disposed in the gap of the double bead portion and the preliminary pressing is performed, so that the inclination in the gap of the double bead portion can be eliminated as shown in FIG. 7B. Therefore, in the manufacturing method according to the present embodiment, it is possible to suppress variation in height of the passage bead portions 53 and 63 and the outer peripheral bead portions 54 and 64.

After the preliminary pressing, the deformation suppressing member 74 is removed from the joint separator 33. From the viewpoint of simplification of the manufacturing process, the deformation suppressing member 74 may be left without being removed from the joint separator 33.

Thereafter, tab joining (welding) and inspection are performed on the joint separator 33, and the manufacturing process of the joint separator 33 of the present embodiment is completed.

The fuel cell stack 10 is manufactured through an assembly step in which the MEAs 28 and the joint separators 33 are alternately stacked, and a tightening step in which current collectors, insulators, and end plates are disposed at both ends of the stack and a predetermined tightening load is applied to the joint separators 33 and the MEAs 28 in the stacking direction by fastening bolts or the like. The fuel cell stack 10 of the present embodiment is excellent in the uniformity of the heights of the passage bead portions 53 and 63 and the outer peripheral bead portions 54 and 64 in the double bead portion, and is therefore excellent in the sealing performance of the reactant gas.

### (Modification 1)

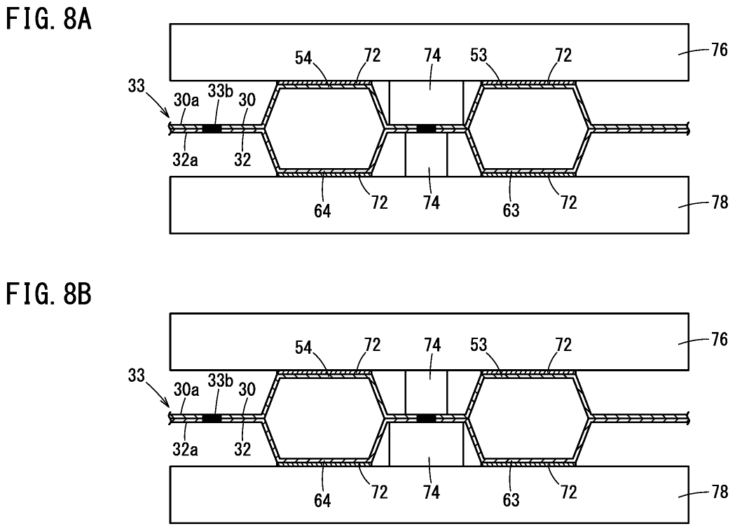

In the present modification, another example of the preliminary pressing step will be described. In this modification, as shown in FIG. 8A, the width of the deformation suppressing member 74 disposed in the double bead portion of the first metal separator 30 is made larger than the width of the deformation suppressing member 74 disposed in the double bead portion of the second metal separator 32. According to this modification, the same effect as that of the first embodiment can be obtained.

### (Modification 2)

In the present modification, still another example of the preliminary pressing step will be described. In this modification, as shown in FIG. 8B, the width of the deformation suppressing member 74 disposed in the double bead portion of the second metal separator 32 is made larger than the width of the deformation suppressing member 74 disposed in the double bead portion of the first metal separator 30. According to this modification, the same effect as that of the first embodiment can be obtained.

The method of manufacturing the fuel cell stack 10 and the method of manufacturing the joint separator 33 according to the present embodiment are summarized below.

An aspect of the present invention is characterized by the method for manufacturing the fuel cell stack 10 including the plurality of power generation cells 12 each including the membrane electrode assembly 28a and the pair of metal separators sandwiching the membrane electrode assembly therebetween, the method including: the forming step of forming each of the first metal separator 30 and the second metal separator 32 by press forming a metal plate, the first metal separator and the second metal separator each including the reactant gas flow field through which the reactant gas flows along the membrane electrode assembly, the outer peripheral bead portion 54, 64 surrounding the periphery of the reactant gas flow field, the passage penetrating therethrough in the separator thickness direction and through which the reactant gas or the coolant flows, and the passage bead portion 53, 63 surrounding the passage; the joining step of joining the first metal separator and the second metal separator to each other in a state of being stacked together in the thickness direction in a manner so that the outer peripheral bead portion of the first metal separator and the outer peripheral bead portion of the second metal separator protrude outward, to thereby form the joint separator 33; the preliminary pressing step of applying the preliminary load to the outer peripheral bead portions and the passage bead portions of the joint separator to thereby plastically deform the outer peripheral bead portions and the passage bead portions; and the assembly step of stacking the joint separator and the membrane electrode assembly, wherein, in the preliminary pressing step, the preliminary load is applied to the outer peripheral bead portions and the passage bead portions while suppressing deformation of a portion between the passage bead portion and the outer peripheral bead portion in the double bead portion formed by the passage bead portion and the outer peripheral bead portion extending in parallel to each other.

According to the above-described method for manufacturing the fuel cell stack, in the so-called double bead portion in which the passage bead portion and the outer peripheral bead portion are adjacent to each other, distortion in the gap between the passage bead portion and the outer peripheral bead portion can be eliminated. Therefore, variation in finished dimensions of the passage bead portion and the outer peripheral bead portion can be suppressed. As a result, the above-described method for manufacturing the fuel cell stack can suppress a decrease in the sealing performance at the double bead portion.

In the fuel cell stack manufacturing method described above, in the preliminary pressing step, the joint separator is sandwiched by the pressing plates from both sides in the thickness direction, whereby the outer peripheral bead portions and the passage bead portions are made uniform in height, and in the preliminary pressing step, the preliminary load is applied while suppressing deformation of a flat portion between the outer peripheral bead portion and the passage bead portion of the double bead portion by disposing, on the flat portion, the deformation suppressing member 74 configured to come into contact with one of the pressing plates. In this manufacturing method, distortion in the gap between the passage bead portion and the outer peripheral bead portion can be eliminated by using the deformation suppressing member. In addition, in the manufacturing method, since it is not necessary to provide a pressing portion on the pressing die, the manufacturing equipment can be simplified.

In the above-described method for manufacturing the fuel cell stack, the deformation suppressing member may be disposed on each of both sides of the flat portion in the thickness direction. In this manufacturing method, distortion of the flat portion between the bead seals of the double bead portion can be eliminated by pressing from both the passage bead portion and the outer peripheral bead portion.

In the above-described method for manufacturing the fuel cell stack, the deformation suppressing member may be disposed at a corner of each of the first metal separator and the second metal separator each having a quadrangular planar shape. The corners of the first metal separator and the second metal separator are portions where a decrease in sealing performance is liable to occur, and by disposing the deformation suppressing member at such portions, the sealing performance of the fuel cell stack can be improved.

In the above-described method for manufacturing the fuel cell stack, the width of the deformation suppressing member disposed on one side of the flat portion in the thickness direction may be larger than the width of the deformation suppressing member disposed on another side of the flat portion in the thickness direction. This manufacturing method can eliminate distortion between the bead seals of the double bead portions.

In the method for manufacturing the fuel cell stack, the deformation suppressing member may be a resin sheet. In this manufacturing method, distortion of the flat portion between the bead seals of the double bead portion can be eliminated by a simple process, i.e., disposing an inexpensive resin sheet, and thus an increase in manufacturing cost can be suppressed.

The above method for manufacturing the fuel cell stack may further include a step of applying the microseal onto the top portions of the passage bead portions and the outer peripheral bead portions after the forming step and before the preliminary pressing step, and the preliminary pressing step may be performed on the passage bead portions and the outer peripheral bead portions on which the microseal is formed. In this manufacturing method, also with respect to the double bead portion having the microseal, it is possible to suppress variation in height of the passage bead portions and the outer peripheral bead portions.

Another aspect of the present invention is characterized by the method for manufacturing the joint separator for use in a fuel cell stack, the method including: the forming step of forming each of the first metal separator and the second metal separator by press forming a metal plate, the first metal separator and the second metal separator each including the reactant gas flow field through which the reactant gas flows along the membrane electrode assembly, the outer peripheral bead portion surrounding the periphery of the reactant gas flow field, the passage penetrating therethrough in the separator thickness direction and through which the reactant gas or the coolant flows, and the passage bead portion surrounding the passage; the joining step of joining the first metal separator and the second metal separator to each other in a state of being stacked together in the thickness direction in a manner so that the outer peripheral bead portion of the first metal separator and the outer peripheral bead portion of the second metal separator protrude outward, to thereby form the joint separator; and the preliminary pressing step of applying the preliminary load to the outer peripheral bead portions and the passage bead portions of the joint separator to thereby plastically deform the outer peripheral bead portions and the passage bead portions, wherein, in the applying of the preliminary load, the preliminary load is applied to the outer peripheral bead portions and the passage bead portions while suppressing deformation of a portion between the passage bead portion and the outer peripheral bead portion in the double bead portion formed by the outer peripheral bead portion and the passage bead portion extending in parallel to each other.

According to the above-described method for manufacturing the joint separator, in the so-called double bead portion in which the passage bead portion and the outer peripheral bead portion are adjacent to each other, distortion in the gap between the passage bead portion and the outer peripheral bead portion can be eliminated. Therefore, variation in finished dimensions of the passage bead portion and the outer peripheral bead portion can be suppressed.

The present invention is not limited to the above-described embodiment, and various configurations can be adopted therein without departing from the essence and gist of the present invention.

1. A method for manufacturing a fuel cell stack including a plurality of power generation cells each including a membrane electrode assembly and a pair of metal separators sandwiching the membrane electrode assembly therebetween, the method comprising:
forming each of a first metal separator and a second metal separator by press forming a metal plate, the first metal separator and the second metal separator each including a reactant gas flow field through which a reactant gas flows along the membrane electrode assembly, an outer peripheral bead portion surrounding a periphery of the reactant gas flow field, a passage penetrating therethrough in a separator thickness direction and through which the reactant gas or a coolant flows, and a passage bead portion surrounding the passage;
joining the first metal separator and the second metal separator to each other in a state of being stacked together in a thickness direction in a manner so that the outer peripheral bead portion of the first metal separator and the outer peripheral bead portion of the second metal separator protrude outward, to thereby form a joint separator;
applying a preliminary load to the outer peripheral bead portions and the passage bead portions of the joint separator to thereby plastically deform the outer peripheral bead portions and the passage bead portions; and
stacking the joint separator and the membrane electrode assembly,
wherein, in the applying of the preliminary load, the preliminary load is applied to the outer peripheral bead portions and the passage bead portions while suppressing deformation of a portion between the passage bead portion and the outer peripheral bead portion in a double bead portion formed by the passage bead portion and the outer peripheral bead portion extending in parallel to each other.

2. The method for manufacturing the fuel cell stack according to claim 1, wherein, in the applying of the preliminary load, the joint separator is sandwiched between pressing plates from both sides in the thickness direction, whereby the outer peripheral bead portions and the passage bead portions are made uniform in height, and
in the applying of the preliminary load, the preliminary load is applied while suppressing deformation of a flat portion between the outer peripheral bead portion and the passage bead portion of the double bead portion by disposing, on the flat portion, a deformation suppressing member configured to come into contact with one of the pressing plates.

3. The method for manufacturing the fuel cell stack according to claim 2, wherein the deformation suppressing member is disposed on each of both sides of the flat portion in the thickness direction.

4. The method for manufacturing the fuel cell stack according to claim 3, wherein a width of the deformation suppressing member disposed on one side of the flat portion in the thickness direction is larger than a width of the deformation suppressing member disposed on another side of the flat portion in the thickness direction.

5. The method for manufacturing the fuel cell stack according to claim 2, wherein
the deformation suppressing member is made of a resin sheet.

6. The method for manufacturing the fuel cell stack according to claim 2, wherein
the deformation suppressing member is disposed at a corner of each of the first metal separator and the second metal separator each having a quadrangular planar shape.

7. The method for manufacturing the fuel cell stack according to claim 1, further comprising applying microseal onto top portions of the passage bead portions and the outer peripheral bead portions after the forming of each of the first metal separator and the second metal separator and before the applying of the preliminary load, wherein in the applying of the preliminary load, the preliminary load is applied to the passage bead portions and the outer peripheral bead portions on which the microseal is formed.

8. A method for manufacturing a joint separator for use in a fuel cell stack, the method comprising:
forming each of a first metal separator and a second metal separator by press forming a metal plate, the first metal separator and the second metal separator each including a reactant gas flow field through which a reactant gas flows along a membrane electrode assembly, an outer peripheral bead portion surrounding a periphery of the reactant gas flow field, a passage penetrating therethrough in a separator thickness direction and through which the reactant gas or a coolant flows, and a passage bead portion surrounding the passage;
joining the first metal separator and the second metal separator to each other in a state of being stacked together in a thickness direction in a manner so that the outer peripheral bead portion of the first metal separator and the outer peripheral bead portion of the second metal separator protrude outward, to thereby form a joint separator; and
applying a preliminary load to the outer peripheral bead portions and the passage bead portions of the joint separator to thereby plastically deform the outer peripheral bead portions and the passage bead portions,
wherein, in the applying of the preliminary load, the preliminary load is applied to the outer peripheral bead portions and the passage bead portions while suppressing deformation of a portion between the passage bead portion and the outer peripheral bead portion in a double bead portion formed by the outer peripheral bead portion and the passage bead portion extending in parallel to each other.
